(19) United States
(12) Patent Application Publication
(10) Pub. No.: US 2025/0294496 A1
(43) Pub. Date: Sep. 18, 2025

(54) METHOD BASED ON NETWORK SLICE USAGE CONTROL AND USER EQUIPMENT USING THE SAME

(71) Applicant: MediaTek Singapore Pte. Ltd., Singapore (SG)

(72) Inventors: Marko Niemi, Oulu (FI); Puneet, Bengaluru (IN)

(21) Appl. No.: 19/071,878

(22) Filed: Mar. 6, 2025

(30) Foreign Application Priority Data
Mar. 15, 2024 (IN) 202421019088

(51) Int. Cl. H04W 60/06

(52) U.S. Cl. CPC H04W 60/06

(57) ABSTRACT

A method based on a network slice usage control and a user equipment (UE) are provided. The method based on the network slice usage control comprises the following steps. A slice deregistration inactivity timer is started when there is no established Protocol Data Unit (PDU) session. The slice deregistration inactivity timer is stopped when a user equipment (UE) enters a 5th Generation Mobility Management DEREGISTERED (5GMM-DEREGISTERED) state, and the slice deregistration inactivity timer is running.

This application claims the benefit of India Provisional application Ser. No. 202421019088, filed Mar. 15, 2024, the disclosure of which is incorporated by reference herein in its entirety.

### TECHNICAL FIELD

The disclosure relates in general to a method and an electronic device using the same, and more particularly to a method based on a network slice usage control and a user equipment (UE) using the same.

### BACKGROUND

If the user equipment (UE) and the network support the network slice usage control, the Access and Mobility Management Function (AMF) monitors the network slice usage by running a slice deregistration inactivity timer per Single-Network Slice Selection Assistance Information (S-NSSAI) and access type. The AMF may also provide on-demand Network Slice Selection Assistance Information (NSSAI) to the UE in a REGISTRATION ACCEPT message or in a CONFIGURATION UPDATE COMMAND message. The on-demand NSSAI consists of one or more on-demand S-NSSAIs and, optionally, the slice deregistration inactivity timer per on-demand S-NSSAI.

However, the UE behavior is undefined when the slice deregistration inactivity timer is running, and the UE is switched off or the Network Slice Selection Assistance Information (NSSAI) is removed.

### SUMMARY

The disclosure is directed to a method based on a network slice usage control and a user equipment (UE) using the same. The UE behavior is defined when a slice deregistration inactivity timer is running, and the UE is switched off or a Universal Subscriber Identity Module (USIM) is removed.

According to one embodiment, a method based on a network slice usage control is provided. The method based on the network slice usage control comprises the following steps. A slice deregistration inactivity timer is started when there is no established Protocol Data Unit (PDU) session. The slice deregistration inactivity timer is stopped when a user equipment (UE) enters a 5th Generation Mobility Management DEREGISTERED (5GMM-DEREGISTERED) state, and the slice deregistration inactivity timer is running.

According to another embodiment, the user equipment (UE) is provided. The UE comprises a transceiver and a processor. The transceiver is configured to wirelessly communicate with a network. The processor is coupled to the transceiver. The processor is configured to perform operations comprising starting a slice deregistration inactivity timer when there is no established Protocol Data Unit (PDU) session; and stopping the slice deregistration inactivity timer when a user equipment (UE) enters a 5th Generation Mobility Management DEREGISTERED (5GMM-DEREGISTERED) state, and the slice deregistration inactivity timer is running.

### BRIEF DESCRIPTION OF THE DRAWINGS

FIG. 1 shows a schematic diagram of a mobile communication system according to an embodiment of the present disclosure.

FIG. 2 shows a flowchart of the method based on the network slice usage control according to one embodiment of the present disclosure.

FIG. 3 illustrates the user equipment (UE) in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

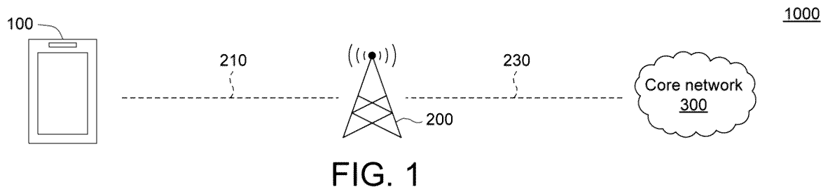

Please refer to FIG. 1, which shows a schematic diagram of a mobile communication system 1000 according to an embodiment of the present disclosure. The mobile communication system 1000 may be a long term evolution (Long Term Evolution, LTE) system, a fifth-generation mobile communication technology 5G new radio (new radio, NR) system, a machine to machine (Machine To Machine, M2M) system, or a future evolved sixth-generation communication system. The mobile communication system 1000 includes a user equipment (UE) 100, a base station 200, a core network device 300. The base station 200 and the core network device 300 may be collectively referred to as a network device.

The base station 200 may be configured to perform mutual conversion between a received radio frame and an IP packet, and may further coordinate attribute management on an air interface. For example, the base station 200 may be an evolved NodeB (evolved NodeB, eNB) in LTE, or a base station that has a centralized distributed architecture and that is used in a 5G system. The base station 200 may also be an access point (AP), a transmission node (Trans Point, TRP), a central unit (CU), or another network entity, and may include some or all of functions of the foregoing network entities. In addition, the base station 200 further includes a relay station. The relay station is a transmission station that receives data and/or other information from an upstream station and sends data and/or other information to a downstream station. The relay station may also be a terminal that provides relay transmission for another terminal. The relay station may also be referred to as a repeater.

The mobile communication system 1000 may be a heterogeneous system including different types of base stations (for example, a macro base station, a picocell base station, a femto base station, and a repeater). These different types of base stations may have different transmit power levels, different coverage areas, and different interference impact. For example, the macro base station may have a high transmit power level (for example, 20 watts), and the picocell station, the femto base station, and the repeater may have a low transmit power level (for example, 1 watt).

The base station 200 and the user equipment 100 establish a radio connection through a radio air interface. The radio air interface may be a radio air interface based on an LTE standard, or the radio air interface is a radio air interface based on a 5G standard. For example, the radio air interface is NR, or the radio air interface may be a radio air interface based on a 5G-based technology standard of a more next-generation mobile communication network.

The user equipment 100 may be a device that provides voice and/or data communication for a user. The user equipment 100 may communicate with one or more core network devices 300 through a radio access network (RAN) provided by the base station 200. The user equipment 100 may be a mobile terminal, for example, a mobile phone or a computer that has a mobile terminal, for example, a portable, pocket-sized, handheld, computer built-in, or vehicle-mounted mobile apparatus.

Specifically, the base station 200 may be configured to communicate with the user equipment 100 through a wireless interface 210 under control of a network device controller (not shown in the FIG. 1). In some embodiments, the network device controller may be a part of the core network device 300, or may be integrated into the base station 200. The base station 200 may transmit information or user data to the core network device 300 through an interface 230 (for example, an S1interface). The base station 200 and the core network device 300 may also communicate with each other through an interface (for example, an X2 interface, which is not shown in the FIG. 1).

In one embodiment, if the user equipment and the network support network slice usage control, the Access and Mobility Management Function (AMF) monitors the network slice usage by running a slice deregistration inactivity timer per Single-Network Slice Selection Assistance Information (S-NSSAI) and access type. The AMF may also provide on-demand Network Slice Selection Assistance Information (NSSAI) to the UE 100 in a REGISTRATION ACCEPT message or in a CONFIGURATION UPDATE COMMAND message. The on-demand NSSAI consists of one or more on-demand S-NSSAIs and, optionally, the slice deregistration inactivity timer per on-demand S-NSSAI.

However, the UE behavior is undefined when the slice deregistration inactivity timer is running, and the UE 100 is switched off or the Network Slice Selection Assistance Information (NSSAI) is removed.

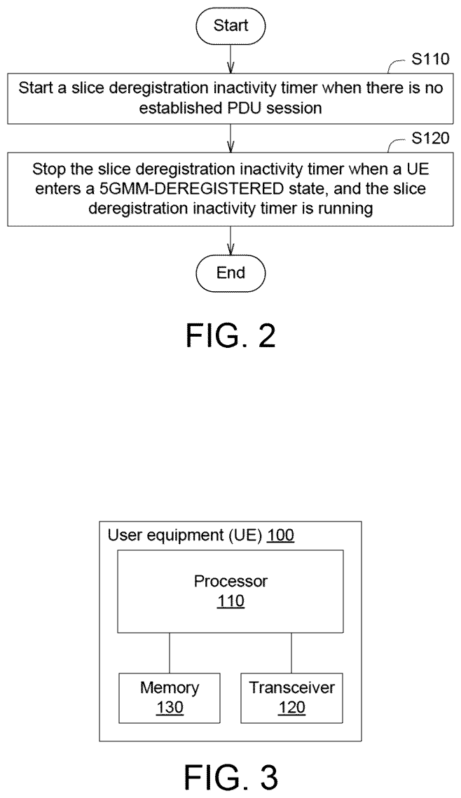

To solve the current problem, a method based on the network slice usage control is provided in this disclosure. Please refer to FIG. 2, which shows a flowchart of the method based on the network slice usage control according to one embodiment of the present disclosure. In this embodiment, the method based on the network slice usage control comprises steps S110 and S120.

In the step S110, the slice deregistration inactivity timer is started when there is no established Protocol Data Unit (PDU) session, including any multi-access protocol data unit (MA PDU) session, associated with the S-NSSAI over the corresponding access type.

In the step S120, the slice deregistration inactivity timer is stopped and reset when at least a PDU session, including any MA PDU session, associated with the S-NSSAI is successfully established over the corresponding access type(s), the S-NSSAI is removed from the allowed NSSAI, or the UE 100 enters a 5th Generation Mobility Management DEREGISTERED (5GMM-DEREGISTERED) state.

If the slice deregistration inactivity timer value is updated, the AMF updates the stored timer value and may provide the updated timer value to the UE 100 in the REGISTRATION ACCEPT message, in a current or the next registration procedure for mobility and periodic registration update, or the CONFIGURATION UPDATE COMMAND message.

When the UE 100 receives an updated slice deregistration inactivity timer value in the REGISTRATION ACCEPT message or the CONFIGURATION UPDATE COMMAND message from the AMF, the UE 100 shall update the stored timer value.

Upon expiry of the slice deregistration inactivity timer, the AMF shall locally remove the S-NSSAI from the allowed NSSAI over the corresponding access type. In addition, the AMF may send the CONFIGURATION UPDATE COMMAND message to the UEs with the new allowed NSSAI.

The UE 100 includes the on-demand S-NSSAI which the UE 100 requests in the requested NSSAI during the registration procedure. Upon expiry of the slice deregistration inactivity timer, the UE 100 shall locally remove the S-NSSAI from the allowed NSSAI over the corresponding access type.

If the UE 100 determines the on-demand S-NSSAI for a PDU session establishment, the UE 100 includes the on-demand S-NSSAI in the requested NSSAI during the registration procedure.

If the UE 100 supports network slice usage control, the AMF provides on-demand NSSAI in the Configured NSSAI to the UE 100 in the REGISTRATION ACCEPT message or in the CONFIGURATION UPDATE COMMAND message. The on-demand NSSAI consists of one or more configured S-NSSAIs.

On-demand NSSAI is associated with the configured NSSAI. The on-demand S-NSSAI(s) is deleted by the UE 100 from the stored on-demand NSSAI, when the associated configured S-NSSAI(s) is deleted by the UE 100 from the stored configured NSSAI.

Based on operator policy, the AMF shall not apply the network slice usage control for the S-NSSAI used for emergency services.

In some embodiments, the UE behavior could be summarized as follows.

When the UE 100 enters to the 5GMM-DEREGISTERED state; and/or the USIM is removed; and/or the UE 100 is switched off; and/or the slice deregistration inactivity timer is running, then the UE 100 can perform one or more of following first alternative action and second alternative action.

The first alternative action is: stop and/or reset the slice deregistration inactivity timer and/or the UE 100 locally removes the S-NSSAI from the allowed NSSAI over the access type.

The second alternative action is: keep the slice deregistration inactivity timer running. For example, if the UE 100 is switched off when the slice deregistration inactivity timer is running, the UE 100 shall behave as follows when the UE 100 is switched on and the USIM in the UE 100 remains the same.

Let t1 be the time remaining for the slice deregistration inactivity timer to timeout at switch off and let t be the time elapsed between switch off and switch on. If t1 is greater than t, then the timer shall be restarted with the value t1-t. If t1 is equal to or less than t, then the slice deregistration inactivity timer need not be restarted and considered expired. If the UE 100 is not capable of determining t, then the UE 100 shall restart the slice deregistration inactivity timer with the value t1.

In one embodiment, the method based on the network slice usage control could comprise starting the slice deregistration inactivity timer when there is no established PDU session and stopping the slice deregistration inactivity timer when the UE 100 enters the 5GMM-DEREGISTERED state and the slice deregistration inactivity timer is running.

In one embodiment, the method based on the network slice usage control could comprise resetting the slice deregistration inactivity timer when the UE 100 enters the 5GMM-DEREGISTERED state and the slice deregistration inactivity timer is running.

In one embodiment, the method based on the network slice usage control could comprise stopping the slice deregistration inactivity timer when the USIM is removed, and the slice deregistration inactivity timer is running.

In one embodiment, the method based on the network slice usage control could comprise resetting the slice deregistration inactivity timer when the USIM is removed, and the slice deregistration inactivity timer is running.

In one embodiment, the method based on the network slice usage control could comprise stopping the slice deregistration inactivity timer when the UE 100 is switched off and the slice deregistration inactivity timer is running.

In one embodiment, the method based on the network slice usage control could comprise resetting the slice deregistration inactivity timer when the UE 100 is switched off and the slice deregistration inactivity timer is running.

In one embodiment, the method based on the network slice usage control could comprise stopping the slice deregistration inactivity timer when the UE 100 is switched off and the slice deregistration inactivity timer is running.

In one embodiment, the method based on the network slice usage control could comprise resetting the slice deregistration inactivity timer when the UE 100 is switched off and the slice deregistration inactivity timer is running.

In one embodiment, the method based on the network slice usage control could comprise keeping the slice deregistration inactivity timer running when the UE 100 is switched on again and a USIM remains the same.

In one embodiment, the method based on the network slice usage control could comprise locally removing, by the UE, the S-NSSAI from an allowed NSSAI over an access type upon expiry of the slice deregistration inactivity timer.

Overall, when the UE 100 enters the 5GMM-DEREGISTERED state (e.g., due to switching off, USIM removal, or disabling 5GS services) and does not stop the slice deregistration timer, the UE 100 will perform one or more of the following operations upon timer expiry: (1) remove either the replaced S-NSSAI or the alternative S-NSSAI from the allowed NSSAI and (2) remove the S-NSSAI from the allowed NSSAI for the corresponding access type. The allowed NSSAI(s) should be stored in non-volatile memory in the Mobile Equipment (ME) so that when the UE 100 is switched on, it can utilize the allowed NSSAI information (read from NVRAM) during the registration procedure for the requested NSSAI from the allowed NSSAI.

If the timer is stopped when the UE 100 enters the 5GMM-DEREGISTERED state, preventing the timer from expiring in this state, then the NSSAI shall not be removed from the allowed NSSAI and can be used in subsequent registration procedures for the requested NSSAI present in the allowed NSSAI.

Please refer to FIG. 3, which illustrates the UE 100 in accordance with an implementation of the present disclosure. The user equipment 100 may perform various functions to implement schemes, techniques, processes and methods described herein pertaining to the UE behavior in mobile communications, including the various schemes described above with respect to various proposed designs, concepts, schemes, systems and methods described above, including the network environment, as well as processes described below.

The UE 100 may be a part of an electronic apparatus, which may be a network apparatus, such as a portable or mobile apparatus, a wearable apparatus, a vehicular device or a vehicle, a wireless communication apparatus or a computing apparatus.

For instance, the UE 100 may be implemented in a smartphone, a smart watch, a personal digital assistant, an electronic control unit (ECU) in a vehicle, a digital camera, or a computing equipment such as a tablet computer, a laptop computer or a notebook computer. The user equipment may also be a part of a machine type apparatus, which may be an IoT apparatus such as an immobile or a stationary apparatus, a home apparatus, a roadside unit (RSU), a wire communication apparatus or a computing apparatus. For instance, the UE 100 may be implemented in a smart thermostat, a smart fridge, a smart door lock, a wireless speaker or a home control center. When implemented in or as a network apparatus, the UE 100 may be implemented in an eNodeB in an LTE, LTE-Advanced or LTE-Advanced Pro network or in a gNB or TRP in a 5G network, an NR network or an IoT network.

In some implementations, the UE 100 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the UE 100 may be implemented in or as a network apparatus. The UE 100 may include at least some of those components shown in the FIG. 3, such as a processor 110, a transceiver 120 and a memory 130, for example. The UE 100 may further include one or more other components not pertinent to the proposed scheme of the present disclosure (e.g., internal power supply, display device and/or user interface device).

In one aspect, the processor 110 may be implemented in the form of one or more single-core processors, one or more multi-core processors, or one or more CISC or RISC processors. That is, even though a singular term “a processor” is used herein to refer to the processor 110, the processor 110 may include multiple processors in some implementations and a single processor in other implementations in accordance with the present disclosure. In another aspect, the processor 110 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the UE 100 behavior for failed registration and service requests for emergency services fallback in mobile communications in accordance with various implementations of the present disclosure.

The transceiver 120 is coupled to the processor 110. The transceiver 120 may be capable of wirelessly transmitting and receiving data. In some implementations, the transceiver 120 may be capable of wirelessly communicating with different types of wireless networks of different radio access technologies (RATs). In some implementations, the transceiver 120 may be equipped with a plurality of antenna ports (not shown) such as, for example, four antenna ports. That is, the transceiver 120 may be equipped with multiple transmit antennas and multiple receive antennas for multiple-input multiple-output (MIMO) wireless communications.

The memory 130 is coupled to the processor 110 and stores data therein. The memory 130 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 130 may include a type of non-volatile random-access memory (NVRAM) such as flash memory, solid-state memory, ferroelectric RAM (FeRAM), magnetoresistive RAM (MRAM) and/or phase-change memory.

The processor 110 of the UE 100, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method based on a network slice usage control, comprising:
starting a slice deregistration inactivity timer when there is no established Protocol Data Unit (PDU) session; and
stopping the slice deregistration inactivity timer when a user equipment (UE) enters a 5th Generation Mobility Management DEREGISTERED (5GMM-DEREGISTERED) state, and the slice deregistration inactivity timer is running.

2. The method according to claim 1, further comprising:
resetting the slice deregistration inactivity timer when the UE enters the 5GMM-DEREGISTERED state, and the slice deregistration inactivity timer is running.

3. The method according to claim 1, further comprising:
stopping the slice deregistration inactivity timer when a Universal Subscriber Identity Module (USIM) is removed, and the slice deregistration inactivity timer is running.

4. The method according to claim 1, further comprising:
resetting the slice deregistration inactivity timer when a Universal Subscriber Identity Module (USIM) is removed, and the slice deregistration inactivity timer is running.

5. The method according to claim 1, further comprising:
stopping the slice deregistration inactivity timer when the UE is switched off and the slice deregistration inactivity timer is running.

6. The method according to claim 1, further comprising:
resetting the slice deregistration inactivity timer when the UE is switched off and the slice deregistration inactivity timer is running.

7. The method according to claim 1, further comprising:
starting the slice deregistration inactivity timer when there is no established Protocol Data Unit (PDU) session, including any multi-access protocol data unit (MA PDU) session.

8. The method according to claim 1, wherein the Protocol Data Unit (PDU) session is associated with Single-Network Slice Selection Assistance Information (S-NSSAI) over corresponding access type when there is no established Protocol Data Unit (PDU) session.

9. The method according to claim 8, further comprising:
keeping the slice deregistration inactivity timer running when the UE is switched on again and a USIM remains the same.

10. The method according to claim 1, further comprising:
locally removing, by the UE, a Single-Network Slice Selection Assistance Information (S-NSSAI) from an allowed Network Slice Selection Assistance Information (NSSAI) over an access type upon expiry of the slice deregistration inactivity timer.

11. A user equipment (UE), comprising:
a transceiver, configured to wirelessly communicate with a network; and
a processor, coupled to the transceiver and configured to perform operations comprising:
starting a slice deregistration inactivity timer when there is no established Protocol Data Unit (PDU) session; and
stopping the slice deregistration inactivity timer when a user equipment (UE) enters a 5th Generation Mobility Management DEREGISTERED (5GMM-DEREGISTERED) state, and the slice deregistration inactivity timer is running.

12. The user equipment (UE) according to claim 11, wherein the operations further comprise:
resetting the slice deregistration inactivity timer when the UE enters the 5GMM-DEREGISTERED state, and the slice deregistration inactivity timer is running.

13. The user equipment (UE) according to claim 11, wherein the operations further comprise:
stopping the slice deregistration inactivity timer when a Universal Subscriber Identity Module (USIM) is removed, and the slice deregistration inactivity timer is running.

14. The user equipment (UE) according to claim 11, wherein the operations further comprise:
resetting the slice deregistration inactivity timer when a Universal Subscriber Identity Module (USIM) is removed, and the slice deregistration inactivity timer is running.

15. The user equipment (UE) according to claim 11, wherein the operations further comprise:
stopping the slice deregistration inactivity timer when the UE is switched off and the slice deregistration inactivity timer is running.

16. The user equipment (UE) according to claim 11, wherein the operations further comprise:
resetting the slice deregistration inactivity timer when the UE is switched off and the slice deregistration inactivity timer is running.

17. The user equipment (UE) according to claim 11, wherein the operations further comprise:
starting the slice deregistration inactivity timer when there is no established Protocol Data Unit (PDU) session, including any multi-access protocol data unit (MA PDU) session.

18. The user equipment (UE) according to claim 11, wherein the Protocol Data Unit (PDU) session is associated with Single-Network Slice Selection Assistance Information (S-NSSAI) over corresponding access type when there is no established Protocol Data Unit (PDU) session.

19. The user equipment (UE) according to claim 18, wherein the operations further comprise:
keeping the slice deregistration inactivity timer running when the UE is switched on again and a USIM remains the same.

20. The user equipment (UE) according to claim 11, wherein the operations further comprise:
locally removing, by the UE, a Single-Network Slice Selection Assistance Information (S-NSSAI) from an allowed Network Slice Selection Assistance Information (NSSAI) over an access type upon expiry of the slice deregistration inactivity timer.
